(19) United States
(12) Patent Application Publication
(10) Pub. No.: US 2008/0154161 A1
(43) Pub. Date: Jun. 26, 2008

(54) HANDHELD MASSAGER

(76) Inventor: LAURA W. ABBOTT, PLEASANTVILLE, NY (US)

Correspondence Address: Lawrence Cruz;Conair Corporation, One Cummings Point Road, STAMFORD, CT, 06902, US

(21) Appl. No.: 11/961,530

(22) Filed: Dec. 20, 2007

Related U.S. Application Data
(60) Provisional application No. 60/876,791, filed on Dec. 22, 2006.

(51) Int. Cl. A61H 15/00

(52) U.S. Cl. 601/113

(57) ABSTRACT

There is provided a handheld device (11) that includes a rolling ball (14) attached to a handle. One or more buttons (16) can be used to control the vibration of the handle (12) and/or rolling ball (14) through the use of motors (22, 24) with eccentric weights (26, 28). In a preferred embodiment of the present disclosure, a lubricating liquid (42a) can be massaged onto a user's body by the rolling ball (14). Within the handle (12) is an oil container (42) to hold the oil or lubricating liquid (42a). The oil (42a) is transferred from the oil container (42) to a wicking element (44). As the rolling ball (44) is moved across a user's skin, the rotation of the rolling ball (44) causes the oil (42a) to transfer from the wicking element (44) onto the rolling ball (14). This oil (42a) is then transferred to the user's skin.

### CROSS REFERENCE TO RELATED APPLICATIONS

This application claims the benefit of and priority to U.S. Provisional Patent Application Ser. No. 60/876,791, filed Dec. 22, 2006, the entire content of which is incorporated by reference herein.

### BACKGROUND

1. Field of the Disclosure

The present disclosure relates to massagers. More particularly, the present disclosure relates to a handheld massager having vibrating capabilities and being adapted to distribute a lubricating liquid onto a roller ball.

2. Description of Related Art

It is known in the art to provide a handheld massager that vibrates, such as a back massager with a vibrating head. However, these devices do not allow for a massager with a vibrating head that distributes a lubricating liquid.

There is a need for a device that can enable a user to selectively distribute a lubricating liquid onto a massager head while also enabling a user to selectively control the vibration of the head and/or massager body.

### SUMMARY

It is an object of the present disclosure to overcome the shortcomings of the prior art mentioned above. These and other objects are achieved by the present disclosure described herein.

The present disclosure achieves these and other objectives by providing a handheld device including a rolling ball attached to a handle. One or more control members can be used to control the vibration of the handle and/or rolling ball through the use of motors with eccentric weights.

In a one embodiment of the present disclosure, a lubricating liquid can be massaged onto a user's body by the rolling ball. Within the handle is, e.g., an oil container to hold the oil or lubricating liquid. The oil is transferred from the oil containing to a wicking element. As the rolling ball is moved across a user's skin, the rotation of the rolling ball causes the oil to transfer from the wicking element onto the rolling ball. This oil is then transferred to the user's skin.

In one embodiment, a handheld massage apparatus includes a handle dimensioned for engagement by a user, a massage element mounted to the handle and adapted to provide a therapeutic effect to a subject, a motor operatively coupled to the massage element to impart motion to the massage element and a lubricating liquid reservoir within the handle and having a lubricating liquid therein. The lubricating liquid reservoir is in fluid communication with the first massage element to distribute lubricating liquid to the massage element for distribution on the subject. An eccentric weight may be coupled to the motor to impart a vibratory motion to the massage element. The massage element may be mounted for rotational movement relative to the handle. In one embodiment, the massage element is a rolling ball. A manual actuator may be mounted to the handle to permit selective actuation by the subject to activate the motor to impart motion to the massage element. A heating element may be disposed within the handle for heating the lubricating liquid. A valve actuable by the subject may be provided to selectively control a volume of liquid distributed to the massage element.

A second massage element may be mounted to the handle and displaced from the first-mentioned massage element. A second motor is operatively coupled to the second massage element to impart motion to the massage element. A second eccentric weight may be coupled to the second motor to impart a vibratory motion to the second massage element. A second manual actuator may be mounted to the handle to permit selective actuation by the subject to activate the second motor to impart motion to the second massage element.

In another embodiment, a handheld massage apparatus includes a handle dimensioned for engagement by a user, a first massage element mounted to the handle and adapted to provide a therapeutic effect to a subject and having a first motor mechanism operatively coupled to the first massage element to impart vibratory motion to the first massage element, a second massage element mounted to the handle and being displaced from the first-mentioned massage element, and having a second motor mechanism operatively coupled to the second massage element to impart vibratory motion to the second massage element and a lubricating liquid reservoir within the handle and having a lubricating liquid therein. The lubricating liquid reservoir is in fluid communication with the first massage element to distribute lubricating liquid to the first massage element for distribution on the subject. The first massage element may include a rotational element adapted for rotational movement relative to the handle. At least one manual actuator is mounted to the handle and selectively actuable by the subject to activate at least one of the first and second motor mechanisms.

### BRIEF DESCRIPTION OF THE DRAWINGS

The present disclosure is more fully understood by reference to the following detailed description of an illustrative embodiment with the drawings identified below.

FIG. 1 is a top perspective view of a massaging device in accordance with a preferred embodiment of the present disclosure;

FIG. 2 is a bottom perspective view of a massaging device in accordance with a preferred embodiment of the present disclosure;

FIG. 3 is a top view of the massaging device in FIG. 1 in accordance with a preferred embodiment of the present disclosure;

FIG. 4 is a bottom view of the massaging device of FIG. 1 in accordance with a preferred embodiment of the present disclosure;

FIG. 5 is a side view of the massaging device of FIG. 1 in accordance with a preferred embodiment of the present disclosure;

FIG. 6 is a cross-sectional view of the massaging device of FIG. 1 taken along the lines 6-6 of FIG. 5 in accordance with a preferred embodiment of the present disclosure;

FIG. 7 is a side cross-sectional view of the massaging device in FIG. 1 taken along the lines 7-7 of FIG. 3 in accordance with a preferred embodiment of the present disclosure;

FIG. 8 is a perspective view of the massaging device of FIG. 1 with the cover transparent to show the internal components.

### DETAILED DESCRIPTION OF THE EMBODIMENTS

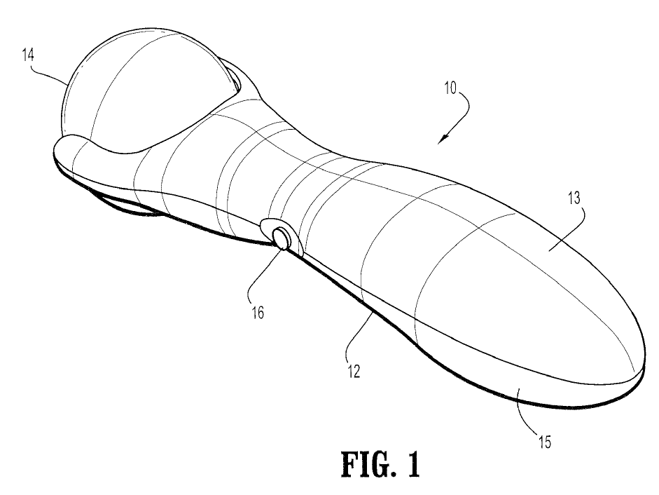

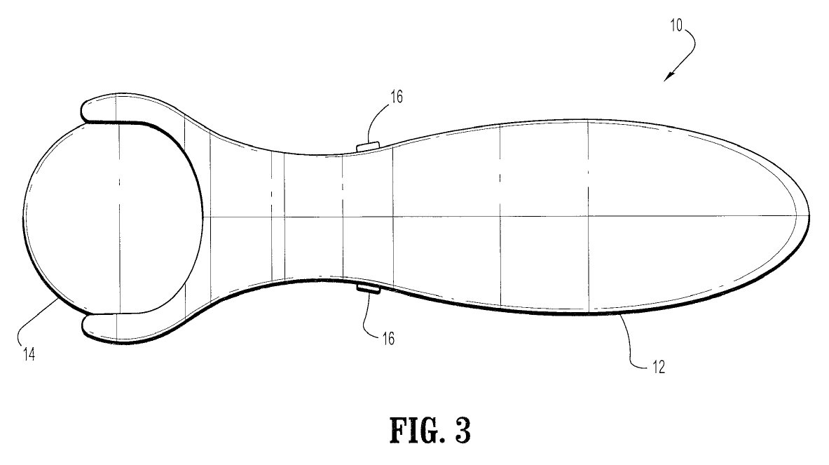

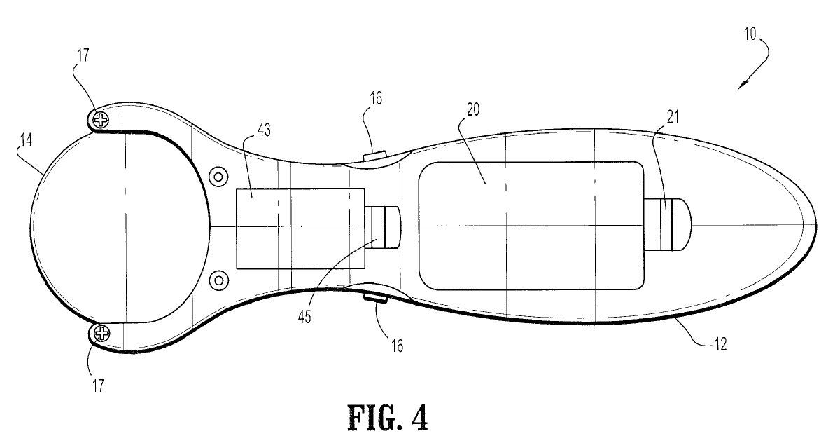

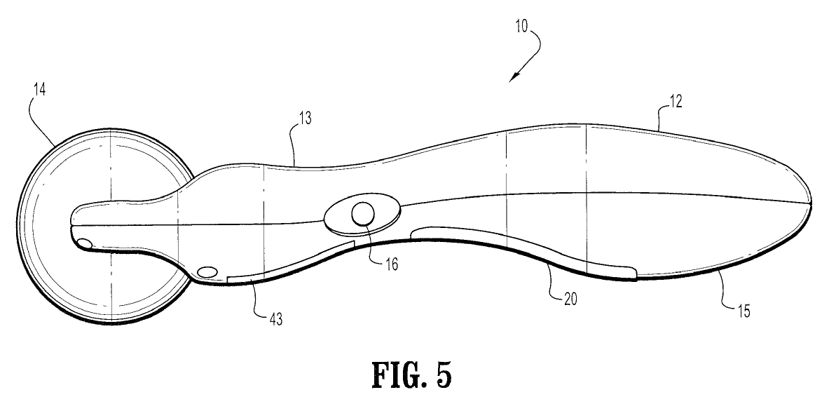

Referring now to details wherein like reference numerals identify similar or like components throughout the several views, FIGS. 1-5 illustrate a massaging device 10 in accordance with the principles of the present disclosure. This massaging device 11 includes a handle 12 and a first massage element which, e.g., may be a rolling ball 14. The handle 12 can be comprised of an upper handle segment 13 and a lower handle segment 15. The upper handle segment 13 and lower handle segment 15 can be secured together with a plurality of screws 17 or by any other suitable method. One or more buttons or manual actuators 16 can be used to operate the massaging device 10.

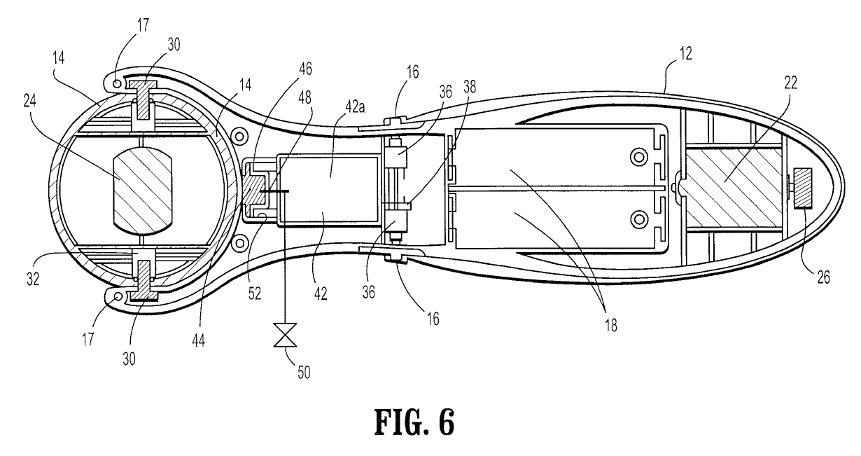

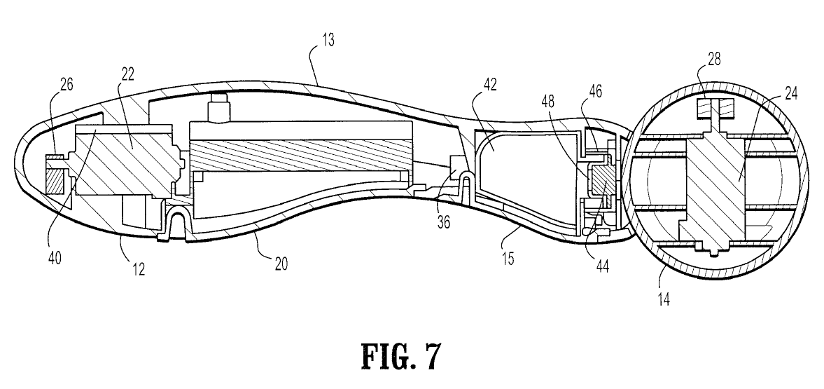

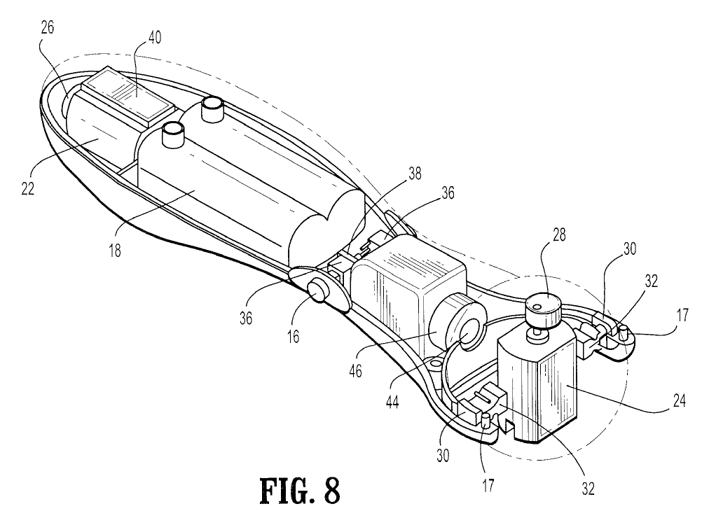

FIG. 6-8 shows the internal components of a preferred embodiment of the massaging device 10. The battery(s) 18 provide power to the massaging device 10 and can be selectively removed from the handle so that they may be replaced when necessary. In an alternate embodiment, a rechargeable cord (not shown) can be used to plug into a power source, rather than using batteries.

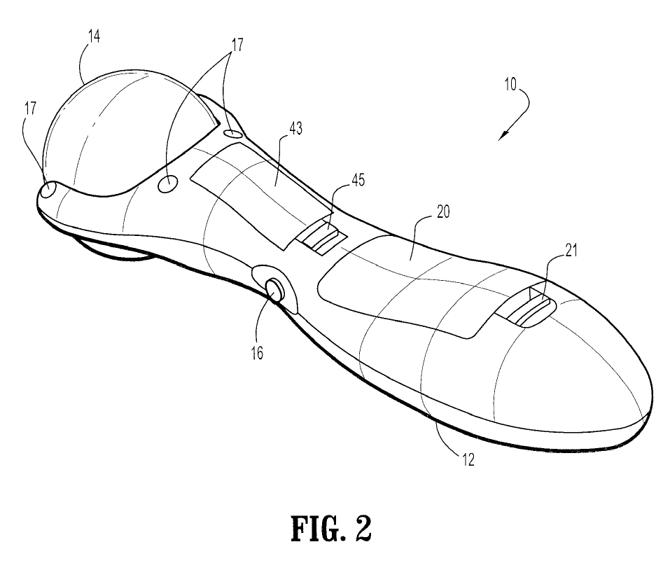

A battery cover 20, as shown in FIG. 2, is located on the lower handle 15. The battery cover 20 can be removed from the lower handle 15 by pulling a battery cover latch 15. The battery cover 20 can then be removed to take out or replace the battery(s) 18. The battery(s) 18 provide power to handle motor 22 and a rolling ball motor 24 so that they each may vibrate. This vibration is accomplished through the use of a handle eccentric weight 26 and a rolling ball eccentric weight 28. These eccentric weights 26, 28 are balanced off center so as they rotate at a rapid rate, they cause respective vibratory movement adjacent their respective ends including roller ball 14 and the end of handle 12.

One or more buttons 16, when depressed, come into contact with the button switches 36. These button switches 36 can be controlled by the control unit 38. The power from the battery(s) 18 is transferred via leads (not shown) to pins 30. This power is then transferred from the pins 30 through the contacts 32 to the motor 22, 24. The motors 22, 24 then rotate the eccentric weights 26, 28 causing the handle 12 and the rolling ball 14 to vibrate. In a preferred embodiment, one button 16 would control the handle motor 22 and the other button 16 would control the rolling ball motor 24. Therefore, a user can select whether the handle 12, the rolling ball 14 or both 12, 14 would vibrate. In the alternate, one button or manual actuator can actuate both motors 22, 24. In one aspect of the present disclosure, a cushion 40 is provided in the handle 12, above the handle motor 22, to prevent the motor from repeatedly coming into contact with the inside of the handle 12, thereby preventing an unintended “clacking” noise from occurring and preserving the instrumental integrity of the handle.

In one preferred embodiment of the present disclosure, a lubricating liquid can be massaged onto a user's body by the rolling ball 14. Within the handle 12 is preferably a liquid or oil container or reservoir 42 to hold oil or lubricating liquid 42a. The oil container 42 is selectively removable from the handle 12 so that it may be replaced when necessary. An oil cover 43 is located on the lower handle 15. The oil cover 43 can be removed by pulling an oil cover latch 45. The oil cover 43 can then be removed to take out or replace an oil container 42. The oil is transferred from the oil containing 42 to a wicking element 44 within the handle 12, via an oil cap 46. The wicking element 44 is preferably made of a permeable material and can absorb an appropriate amount of oil. Some materials for wicking 44 may include sponges, cloths or the like. In one embodiment of the present disclosure, there may be an intermediate material 49 to transfer the oil onto the rolling ball 14. Once the oil is on the rolling ball 14, it is transferred to a user's body by rolling the rolling ball 14 across a user's skin. As the rolling ball 14 rotates, more oil is transferred from the wicking element 44 or intermediate material 49 onto the rolling ball 14. Oil cap 46 is provided to function in preventing the wicking 44 from being pushed radially outwardly during use. An inner cover 48 prevents the wicking element 44 from being pushed radially inwardly. In one embodiment, an additional button or switch (not shown) can control a valve, schematically illustrated as reference numeral 50, (FIG. 6) be to enable a user to selectively control the volume of oil transferred to the rolling ball 14. In an alternate embodiment of the present disclosure, a heater represented schematically as reference numeral 52 (FIG. 6), can be included in the handle 12 to heat the oil or lubricating liquid before applying to a user's body. The heater 52 may be a resistive coil in communication with the flow of the lubricating liquid from the oil container 42 to rolling ball 14.

While a preferred embodiment of the disclosure has been herein disclosed and described, it is understood that various modifications can be made without departing from the scope of the disclosure.

What is claimed:

1. A handheld massage apparatus, which comprises:
a handle dimensioned for engagement by a user;
a massage element mounted to the handle and adapted to provide a therapeutic effect to a subject;
a motor operatively coupled to the massage element to impart motion to the massage element; and
a lubricating liquid reservoir within the handle and having a lubricating liquid therein, the lubricating liquid reservoir in fluid communication with the first massage element to distribute lubricating liquid to the massage element for distribution on the subject.

2. The handheld massage apparatus according to claim 1 including an eccentric weight coupled to the motor to impart a vibratory motion to the massage element.

3. The handheld massage apparatus according to claim 1 wherein the massage element is mounted for rotational movement relative to the handle.

4. The handheld massage apparatus according to claim 3 wherein the massage element is a rolling ball.

5. The handheld massage apparatus according to claim 1 including a manual actuator mounted to the handle, the manual actuator selectively actuable by the subject to activate the motor to impart motion to the massage element.

6. The handheld massage apparatus according to claim 1 including a heating element disposed within the handle for heating the lubricating liquid.

7. The handheld massage apparatus according to claim 1 including a valve actuable by the subject, the valve adapted to selectively control a volume of liquid distributed to the massage element.

8. The handheld massage apparatus according to claim 1 including a second massage element mounted to the handle and being displaced from the first-mentioned massage element.

9. The handheld massage apparatus according to claim 8 including a second motor operatively coupled to the second massage element to impart motion to the massage element.

10. The handheld massage apparatus according to claim 9 including a second eccentric weight coupled to the second motor to impart a vibratory motion to the second massage element.

11. The handheld massage apparatus according to claim 10 including a second manual actuator mounted to the handle, the second manual actuator selectively actuable by the subject to activate the second motor to impart motion to the second massage element.

12. A handheld massage apparatus, which comprises:
a handle dimensioned for engagement by a user;
a first massage element mounted to the handle and adapted to provide a therapeutic effect to a subject and having a first motor mechanism operatively coupled to the first massage element to impart vibratory motion to the first massage element;
a second massage element mounted to the handle and being displaced from the first-mentioned massage element, and having a second motor mechanism operatively coupled to the second massage element to impart vibratory motion to the second massage element; and
a lubricating liquid reservoir within the handle and having a lubricating liquid therein, the lubricating liquid reservoir in fluid communication with the first massage element to distribute lubricating liquid to the first massage element for distribution on the subject.

13. The handheld massage apparatus according to claim 12 wherein the first massage element includes a rotational element adapted for rotational movement relative to the handle.

14. The handheld massage apparatus according to claim 13 including at least one manual actuator mounted to the handle, the manual actuator selectively actuable by the subject to activate at least one of the first and second motor mechanisms.
